(19) United States
(12) Patent Application Publication
(10) Pub. No.: US 2020/0162655 A1
(43) Pub. Date: May 21, 2020

(54) EXPOSURE CONTROL METHOD AND DEVICE, AND UNMANNED AERIAL VEHICLE

(71) Applicant: SZ DJI TECHNOLOGY CO., LTD., Shenzhen (CN)

(72) Inventors: You ZHOU, Shenzhen (CN); Jiexi DU, Shenzhen (CN); Jianzhao CAI, Shenzhen (CN)

(21) Appl. No.: 16/748,973

(22) Filed: Jan. 22, 2020

Related U.S. Application Data
(63) Continuation of application No. PCT/CN2017/099069, filed on Aug. 25, 2017.

(51) Int. Cl. H04N 5/235; G06T 7/557; G05D 1/00; G05D 1/10; G05D 1/12; B64C 39/02

(52) U.S. Cl. CPC H04N 5/2353; H04N 5/2351; G06T 7/557; B64C 2201/123; G05D 1/101; G05D 1/12; B64C 39/024; G05D 1/0094

(57) ABSTRACT

An exposure control method is provided for a control device. The method includes acquiring an output image from data outputted by a depth sensor according to a current exposure parameter, determining a target image of a target object in the output image, and determining a first exposure parameter according to the brightness of the target image. The first exposure parameter is used for controlling the next exposure of the depth sensor.

### CROSS-REFERENCE TO RELATED APPLICATION

This application is a continuation of International Application No. PCT/CN2017/099069, filed Aug. 25, 2017, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates to the field of control technology and, more particularly, to a method and device for controlling exposure, and an unmanned aerial vehicle (UAV).

### BACKGROUND

At present, acquiring depth images through depth sensors, and using depth images to identify and track target objects are important means of target object detection. However, when a target object is in a high dynamic scenario, e.g., when a user in white cloths stands in front of a black curtain and the user's hand gestures need to be identified, overexposure or underexposure of the target object may happen with current exposure control methods of depth sensor technologies. The overexposure or underexposure may cause part of the depth values of a depth image acquired from a depth sensor to become invalid values, thereby leading to the failure of detection and identification of a target object.

### SUMMARY

In accordance with the disclosure, an exposure control method includes acquiring an output image from data outputted by a depth sensor according to a current exposure parameter, determining a target image of a target object in the output image, and determining a first exposure parameter according to the brightness of the target image. The first exposure parameter is used for controlling the next exposure of the depth sensor.

Also in accordance with the disclosure, an exposure control device includes a memory device and a processor. The memory device is configured to store program instructions. The processor is configured to call the program instructions. When the processor executes the program instructions, the processor acquires an output image from data outputted by a depth sensor according to a current exposure parameter, determines a target image of a target object in the output image, and determines a first exposure parameter according to the brightness of the target image. The first exposure parameter is used for controlling the next exposure of the depth sensor.

### BRIEF DESCRIPTION OF THE DRAWINGS

FIG. 1 is a schematic flow chart of an exposure control method according to an exemplary embodiment of the present invention;

FIG. 2 is a schematic diagram of identifying an image of a target object in another image according to another exemplary embodiment of the present invention;

FIG. 3 is a schematic flow chart of another exposure control method according to another exemplary embodiment of the present invention;

FIG. 4 is a schematic flow chart of another exposure control method according to another exemplary embodiment of the present invention;

FIG. 5 is a schematic flow chart of another exposure control method according to another exemplary embodiment of the present invention;

FIG. 6 is a schematic block diagram of an exposure control device according to another exemplary embodiment of the present invention; and

FIG. 7 is a schematic structural diagram of an unmanned aerial vehicle according to another exemplary embodiment of the present invention.

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

As used herein, when a first component is referred to as “fixed to” a second component, it is intended that the first component may be directly attached to the second component or may be indirectly attached to the second component via another component. When a first component is referred to as “connecting” to a second component, it is intended that the first component may be directly connected to the second component or may be indirectly connected to the second component via a third component between them.

Unless otherwise defined, all the technical and scientific terms used herein have the same or similar meanings as generally understood by one of ordinary skill in the art. As described herein, the terms used in the specification of the present disclosure are intended to describe exemplary embodiments, instead of limiting the present disclosure. The term “and/or” used herein includes any suitable combination of one or more related items listed.

Exemplary embodiments will be described with reference to the accompanying drawings, in which the same numbers refer to the same or similar elements unless otherwise specified. Features in various embodiments may be combined, when there is no conflict.

Currently, the exposure strategy of depth sensors is based on the global brightness within a detection range. That is, exposure parameters such as an exposure time, an exposure gain, and so on are adjusted to achieve an expected brightness level based on the global brightness. As such, when a target object is in a high dynamic environment (e.g., in a scene with a fast alternation between brightness and darkness), overexposure or underexposure of a target object can occur if exposure parameters of a depth sensor are adjusted using the global brightness. Thus, depth images acquired from the depth sensor may become inaccurate and certain depth values of a depth image may be invalid values. The target object may not be detected in the depth image or a detection error may happen. The present disclosure adjusts exposure parameters of a depth sensor based on the brightness of a target object in an image outputted from a depth sensor. As such, overexposure or underexposure of a target object may be prevented effectively. Depth images outputted from a depth sensor may become more accurate. Hereinafter, exemplary embodiments of exposure control methods will be described in more detail with reference to examples below.

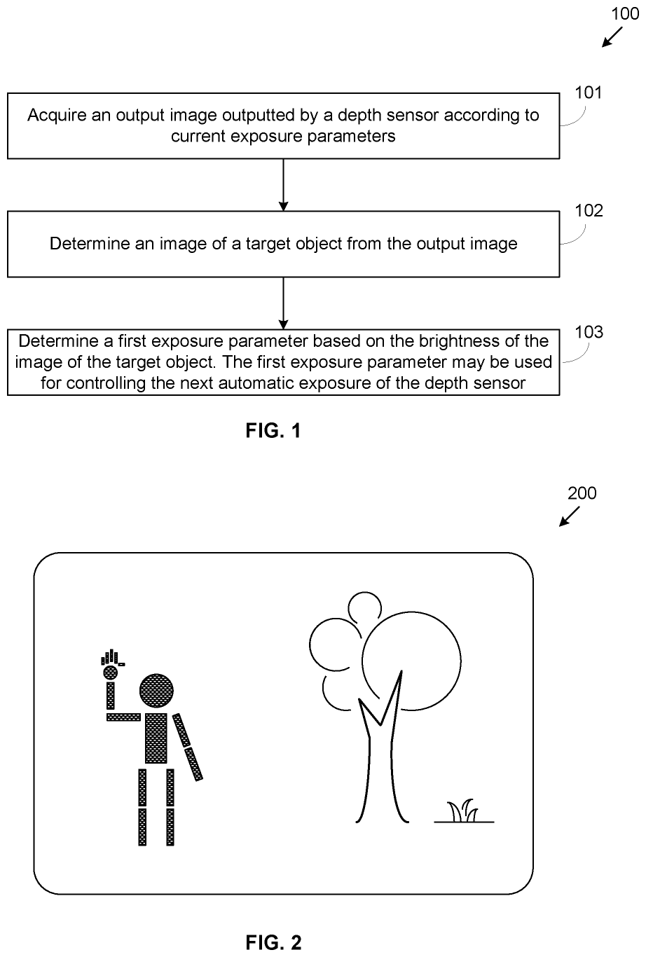

The present disclosure provides a method for exposure control. FIG. 1 illustrates a schematic flow chart 100 of an exemplary method for exposure control consistent with the disclosure. As shown in FIG. 1, the exemplary method may include the following steps.

At step 101, an output image outputted by a depth sensor may be acquired according to current exposure parameters.

Specifically, an execution body of the control method may be an exposure control device, which may include a processor of the exposure control device. The processor may be of an application-specific processor or a general-purpose processor. The depth sensor may be arranged to photograph the environment within a detection range using automatic exposure with the current exposure parameters. As a target object (e.g., a user) is in the detection range of the depth sensor, an image filmed may include an image of the target object. The target object may be an object that needs to be identified. The processor may be connected to the depth sensor electrically and receive output images that are outputted by the depth sensor. The depth sensor may be any sensor that outputs depth images or data of depth images. The depth sensor may also be any sensor that outputs images or data of images, from which depth images may be obtained by, for example, a processor. Specifically, the depth sensor may include one or more of a binocular camera, a monocular camera, an RGB camera, a TOF camera, or an RGB-D camera, where RGB stands for color red, green, and blue, TOF stands for time-of-flight, and an RGB-D camera is a depth sensing device that works in association with an RGB camera. Further, the depth images and/or the image outputted from the depth sensor may include a grayscale image or an RGB image. The exposure parameters may include one or more of an exposure time, an exposure gain, and an aperture value, etc.

At step 102, an image of the target object may be determined from the output image acquired from the depth sensor.

Specifically, the processor may be arranged to identify an image that corresponds to the target object in the output image, after the processor obtains the output image from the depth sensor. For example, as shown in FIG. 2, when a depth sensor is used to recognize hand gestures of a user in an output image, an image corresponding to the user may be identified from the entire output image.

At step 103, a first exposure parameter may be determined based on the brightness of the image of the target object. The first exposure parameter may be used for controlling the next automatic exposure of the depth sensor.

Specifically, after the image of the target object is identified in the output image, the brightness information on the image of the target object may be obtained. The first exposure parameter may be determined according to the brightness information on the image of the target object. The first exposure parameter may be used to control the next automatic exposure of the depth sensor. Further, the first exposure parameter may be the exposure parameter that controls the next automatic exposure of the depth sensor. That is, the first exposure parameter may become the current exposure parameter at the next exposure.

The present disclosure provides an exposure control method that identifies an image of a target object from an output image outputted by a depth sensor. A first exposure parameter may be determined based on the brightness of the image of the target object. The first exposure parameter may be used to control the next automatic exposure of the depth sensor. The method may prevent overexposure or underexposure of the target object in the output image. The method may also make depth images acquired by the depth sensor be more conducive to detection and identification of a target object. As such, detection accuracy of a target object by a depth sensor may be improved.

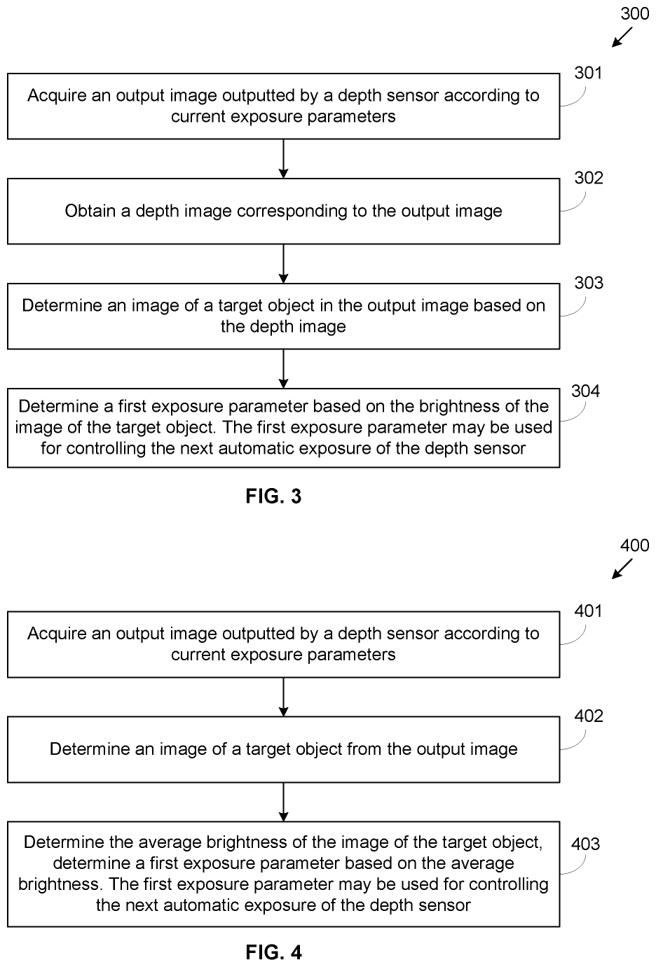

FIG. 3 illustrates a schematic flow chart 300 of another exemplary method for exposure control consistent with the present disclosure. The exemplary method shown in FIG. 3 may be based on the exemplary method shown in FIG. 1 and include the following steps.

At step 301, an output image outputted by a depth sensor may be acquired according to current exposure parameters. In some embodiments, the depth sensor may output data from which a grayscale image may be formed. In some other embodiments, the depth sensor may output data from which a depth image may be formed.

As step 301 is consistent with the method and principles of step 101, detailed description of step 301 is omitted here.

At step 302, a depth image corresponding to the output image may be obtained when the output image is a grayscale image. If the output image is a depth image, step 302 is simplified as the output image may be used as the depth image.

Specifically, the depth image corresponding to the output image may be obtained by a processor. The depth image may be used to detect and identify a target object. The depth image corresponding to the output image may be acquired by the following methods.

In one method, a depth image corresponding to the output image may be obtained from the depth sensor. Specifically, some depth sensors may output a corresponding depth image in addition to supplying an output image. For example, besides outputting a grayscale image, a TOF camera may also output a depth image that corresponds to the grayscale image. A processor may obtain the depth image corresponding to the output image.

In another method, the depth image may be obtained from grayscale images, and obtaining grayscale images outputted from a depth sensor may include obtaining at least two grayscale images outputted by the depth sensor. Obtaining a depth image corresponding to grayscale images includes obtaining the depth image based on the at least two grayscale images. Specifically, some depth sensor cannot output a depth image directly and depth images are determined based on grayscale images outputted by the depth sensor. For example, when a depth sensor is a binocular camera, the binocular camera may output two grayscale images simultaneously (e.g., a grayscale image outputted by a left-eye camera and another grayscale image outputted by a right-eye camera). The processor may calculate a depth image using the two grayscale images. Additionally, a depth sensor may be a monocular camera. In such a scenario, the processor may acquire two consecutive grayscale images outputted by the monocular camera and determine a depth image based on the two consecutive grayscale images.

At step 303, an image of a target object in the output image may be determined based on the depth image.

Specifically, after the depth image corresponding to the output image is obtained, an image of the target object in the output image may be determined based on the depth image, i.e., determining an image belonging to the target object from the entire output image.

In some embodiments, determining an image of the target object in the output image based on a depth image may include determining a grayscale image of the target object from one of the at least two grayscale images based on the depth image. Specifically, as aforementioned, at least two grayscale images may be outputted by the depth sensor and the processor may obtain the depth image using the at least two grayscale images. Further, the processor may determine an image of the target object from one of the at least two grayscale images based on the depth image. For example, when the depth sensor is a binocular camera, the binocular camera may output two grayscale images simultaneously (e.g., a grayscale image outputted by a left-eye camera and another grayscale image outputted by a right-eye camera). When a depth image is calculated, the grayscale image from the right-eye camera may be projected or mapped to the grayscale image from the left-eye camera to calculate the depth image. As such, an image of the target object may be determined in the grayscale image from the left-eye camera according to the depth image.

Further, the following exemplary procedures may be implemented to determine the image of the target object in the output image according to the depth image. The exemplary procedures may include determine a first target region of the target object in the output image according to the depth image; and determining the image of the target object in the output image according to the first target region. Specifically, the first target region of the target object in the output image may be determined according to the depth image. The first target region is the region occupied by the target object in the output image. Hence, the region of the target object in the output image may be determined. After the first target region is determined, the image of the target object may be obtained in the first target region.

Further, determining the first target region of the target object in the output image according to the depth image may include determining a second target region of the target object in the depth image; and determining the first target region of the target object in the output image according to the second target region. Specifically, after obtaining the depth image, the region that the target object occupies in the depth image, i.e., the second target region, may be determined first, since it is relatively convenient to detect and identify a target in the depth image. Because of the mapping relationship between the depth image and the corresponding output image, the region that the target object occupies in the output image, i.e., the first target region, may be determined according to the second target region of the target object, after the second target region of the target object is obtained in the depth image.

Further, determining the second target region of the target object in the depth image may include determining connection regions in the depth image; and determining a connection region that satisfies preset requirements as the second target region of the target object in the depth image. Specifically, as the depth information on a target object usually changes continuously, connection regions may be determined in the depth image. A region occupied by the target object in the depth image may be one or more of the connection regions. Characteristics of each connection region may be determined by the processor, and a connection region that satisfies the preset requirements may be determined as the second target region.

Further, determining a connection region that satisfies the preset requirements as the second target region of the target object in the depth image may includes among the connection regions, determining the average depth of each connection region; and when the number of pixels in a connection region is greater than or equal to a pixel quantity threshold that corresponds to the average depth of the connection region, determining the connection region as the second target region of the target object in the depth image.

Specifically, because the size of a target object or the size of part of a target object is certain, e.g., generally the area of the upper body of a user is about 0.4 square meters (technicians in the field may adjust it according to actual conditions) when a target object is the user, the size of an area a target object occupies in a depth image is related to the distance between the target object and the depth sensor if the area of the target object does not change. That is, the number of corresponding pixels of a target object in a depth image is related to the distance between the target object and the depth sensor. When the target object is closer to the depth sensor, the number of corresponding pixels of the target object in the depth sensor is greater. When the target object is farther away from the depth sensor, the number of corresponding pixels of the target object in the depth sensor is less. For example, when a user is 0.5 meter away from a depth sensor, the number of corresponding pixels of the user in a depth image may be 12250 (assuming resolution is 320*240 and focal length f is about 350). On the other hand, when the user is 1 meter away from the depth sensor, the number of corresponding pixels of the user in the depth image may be 3062. Hence, different pixel quantity thresholds may be arranged for different distances. Each distance may have a corresponding pixel quantity threshold. The processor may be configured to filter connection regions and determine the average depth of each connection region. When the pixel number of a connection region is greater than or equal to a pixel quantity threshold corresponding to the average depth of the connection region, the connection region may be determined as the second target region of a target object in the depth image.

Further, when the pixel number of a connection region is larger than or equal to the pixel quantity threshold corresponding to the average depth of the connection region, another condition may be added for determining a second target region, that is, when the pixel number of a connection region is larger than or equal to the pixel quantity threshold corresponding to the average depth of the connection region and the connection region has the smallest average depth among all connection regions having such pixel number, the connection region may be determined as the second target region of the target object in the depth image. Specifically, when connection regions are searched and filtered by the processor, the processor may be configured to start a search from connection regions that have relatively small average depths. That is, the processor may rank the connection regions first based on the average depth, and may start the search from the connection region with the smallest average depth. As such, the processor may be configured to stop searching when finding a connection region whose pixel number is larger than or equal to a pixel quantity threshold corresponding to the average depth of the connection region. Accordingly, the processor may determine the connection region found in the search as the second target region of the target object in the depth image. In general, when detecting a target object, such as detecting a user or detecting hand gestures of a user, the distance between the user and the depth sensor should be minimal. Hence, a connection region whose total pixel number is greater than or equal to a pixel quantity threshold corresponding to the average depth of the connection region and whose average depth is the smallest may be determined as the second target region of the target object in the depth image.

At step 304, a first exposure parameter may be determined based on the brightness of the image of the target object. The first exposure parameter may be used for controlling the next automatic exposure of the depth sensor.

As step 304 is consistent with the method and principles of step 103, detailed description of step 304 is omitted here.

FIG. 4 illustrates a schematic flow chart 400 of another exemplary method for exposure control consistent with the present disclosure. The exemplary method shown in FIG. 4 may be based on the exemplary methods shown in FIGS. 1 and 3 and include the following steps.

At step 401, an output image outputted by a depth sensor may be acquired according to current exposure parameters.

As step 401 is consistent with the method and principles of step 101, detailed description of step 401 is omitted here.

At step 402, an image of a target object may be determined from the output image.

As step 402 is consistent with the method and principles of step 102, detailed description of step 402 is omitted here.

At step 403, the average brightness of the image of the target object may be determined. Further, a first exposure parameter may be determined based on the average brightness. The first exposure parameter may be used for controlling the next automatic exposure of the depth sensor.

Specifically, after the image of the target object is determined, the average brightness of the target object may be determined, and the first exposure parameter may be determined according to the average brightness.

Further, determining the first exposure parameter according to the average brightness may include determining the first exposure parameter according to the average brightness and the preset brightness. Specifically, a difference value between the average brightness and preset brightness may be determined. The first exposure parameter may be determined according to the difference value when the difference value is greater than or equal to a preset brightness threshold value. The average brightness may be the average brightness of the image of the target object, i.e., the image corresponding to the target object in the current output image. The preset brightness may be the expected average brightness of a target object. When the difference value between the average brightness of a target object in a current output image and the preset brightness is large, the depth image obtained by a depth sensor may be detrimental to the detection and identification of the target object. Accordingly, the first exposure parameter may be determined based on the difference value and used to control the next automatic exposure of the depth sensor. When the difference value is less than the preset brightness threshold, it may indicate that the average brightness of the target object in the image is converged to the preset brightness or close to be converged to the preset brightness. As such, adjustment of exposure parameters may no longer be needed for the next automatic exposure of the depth sensor.

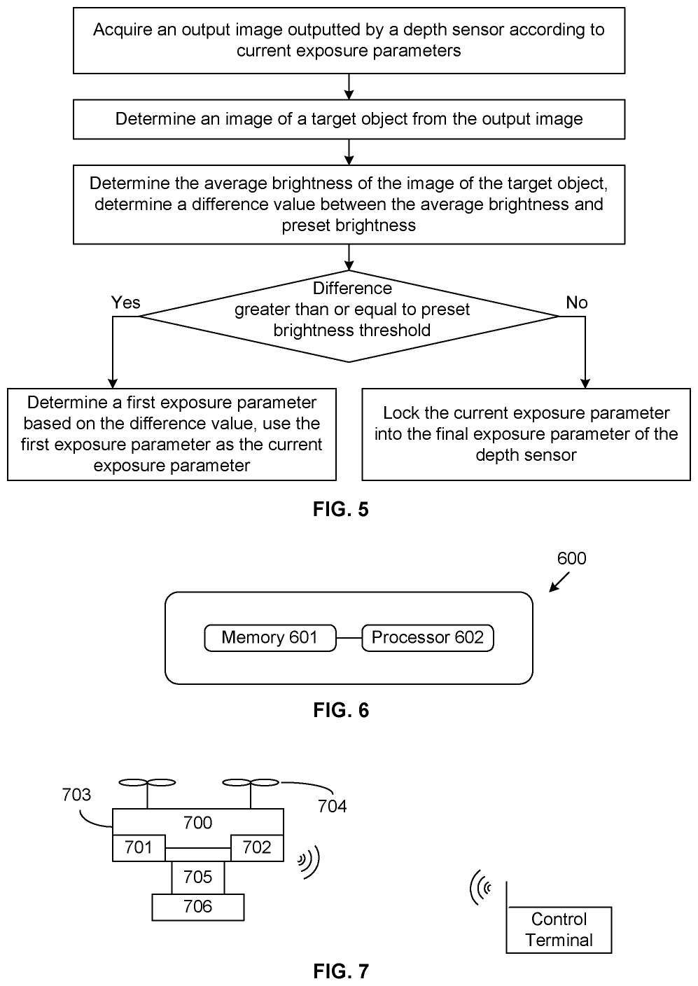

At the next automatic exposure of the depth sensor, the first exposure parameter may be determined as the current exposure parameter to control the automatic exposure of the depth sensor. The above-mentioned steps may be repeated until the difference value is less than the preset brightness threshold. Accordingly, the current exposure parameter may be locked into the final exposure parameter for controlling automatic exposure of the depth sensor. Specifically, as shown in FIG. 5, the first exposure parameter may be used to control the next exposure of the depth sensor when the first exposure parameter is determined. Specifically, the first exposure parameter may be used as the current exposure parameter when the next automatic exposure is implemented. The depth sensor may perform automatic exposure according to the current exposure parameter. The processor may acquire an output image outputted by the depth sensor and determine an image of a target object in the output image. The processor may determine the average brightness of the image of the target object and further determines whether a difference value between the average brightness and the preset brightness is greater than a preset brightness threshold value. The processor may determine a new first exposure parameter according to the difference value when the difference value is greater than the preset brightness threshold value. Consequently, the above steps, including the step of determining the difference value and the step of determining the first exposure parameter, may be repeated. When the difference value is less than the preset brightness threshold value, determining the first exposure parameter may be stopped and the current exposure parameter may be locked into the final exposure parameter of the depth sensor. Accordingly, the final exposure parameter may be used to control exposure of the depth sensor for subsequent automatic exposures of the depth sensor.

In practical applications, a target object (e.g., a user) or part of a target object may be detected, or hand gestures of a user may be detected. For example, a depth image may be acquired from a depth sensor and hand gestures of a user may be detected from the depth image by a processor. In such scenarios, the average brightness of the user in the image may be rapidly converged to a preset brightness using exposure control methods disclosed in the above embodiments. Further, the current exposure parameter may be locked into the final exposure parameter. Subsequent exposures of the depth sensor may be controlled using the final exposure parameter. When a detection of a target object fails, the exposure parameter of the depth sensor may be re-determined using exposure control methods disclosed in the above embodiments.

FIG. 6 schematically shows a structural block diagram of an exposure control device 600 consistent with the present disclosure. As shown in FIG. 6, the device 600 may include a memory device 601 and a processor 602.

The memory device 601 may be used to store program instructions.

The processor 602 may be used to call the program instructions. When the program instruction is executed, the processor 602 may be configured to acquire an output image outputted by a depth sensor according to current exposure parameters; determine an image of a target object in the output image; and determine a first exposure parameter according to the brightness of the image of the target object, wherein the first exposure parameter may be used for controlling the next automatic exposure of the depth sensor.

In some embodiments, the processor 602 may also be used to acquire a depth image corresponding to the output image.

When the processor 602 is used to determine the image of the target object in the output image, the processor 602 may be specifically configured to determine the image of the target object in the output image based on the depth image.

In some embodiments, when the processor 602 determines the image of the target object in the output image based on the depth image, the processor 602 may be specifically configured to determine a first target region of the target object in the output image according to the depth image; and determine the image of the target object in the output image according to the first target region.

In some embodiments, when the processor 602 determines the first target region of the target object in the output image according to the depth image, the processor 602 may be specifically configured to determine a second target region of the target object in the depth image; and determine the first target region of the target object in the output image according to the second target region.

In some embodiments, when the processor 602 determines the second target region of the target object in the depth image, the processor 602 may be specifically configured to determine connection regions in the depth image; and determine a connection region that satisfies preset requirements as the second target region of the target object in the depth image.

In some embodiments, when the processor 602 determines whether a connection region satisfies the preset requirements, the processor 602 may be specifically configured to determine the average depth of each connection region; and determine a connection region whose pixel number is greater than or equal to a pixel quantity threshold corresponding to the average depth of the connection region as the second target region of the target object in the depth image.

In some embodiments, when the processor 602 determines the connection region whose pixel number is greater than or equal to the pixel quantity threshold corresponding to the average depth of the connection region as the second target region of the target object in the depth image, the processor 602 may be specifically configured to determine the connection region whose pixel number is greater than or equal to the pixel quantity threshold corresponding to the average depth of the connection region and whose average depth is the smallest as the second target region of the target object in the depth image.

In some embodiments, when the processor 602 acquires grayscale images outputted from the depth sensor, the processor 602 may be specifically configured to acquire at least two grayscale images outputted from the depth sensor.

When the processor 602 acquires a depth image corresponding to grayscale images, the processor 602 may be specifically configured to acquire the depth image according to the at least two grayscale images.

In some embodiments, when the processor 602 determines an image within a target region in the output image based on the depth image, the processor 602 may be specifically configured to determine a grayscale image of the target object from one image of the at least two grayscale images according to the depth image.

In some embodiments, when the processor 602 determines a first exposure parameter according to the brightness of the image of the target object, the processor 602 may be specifically configured to determine the average brightness of the image of the target object; and determine the first exposure parameter based on the average brightness.

In some embodiments, when the processor 602 determines the first exposure parameter according to the average brightness and the preset brightness, the processor 602 may be specifically configured to determine a difference value between the average brightness and the preset brightness; and determine the first exposure parameter according to the difference value when the difference value is greater than a brightness threshold value.

In some embodiments, the processor 602 may also be specifically configured to determine the first exposure parameter as the current exposure parameter, repeat the above-mentioned steps until the difference value is less than or equal to the brightness threshold value; and lock the current exposure parameter into the final exposure parameter for controlling automatic exposure of the depth sensor.

In some embodiments, the depth sensor may include at least one of a binocular camera or a TOF camera.

In some embodiments, the exposure parameter may include at least one of an exposure time, an exposure gain, or an aperture value.

The present disclosure also provides an unmanned aerial vehicle. FIG. 7 schematically shows a structural block diagram of an unmanned aerial vehicle 700 or drone 700 consistent with the disclosure. As shown in FIG. 7, the drone 700 may include an exposure control device 701 that may be any one of the aforementioned embodiments.

Specifically, the drone 700 may also include a depth sensor 702. The exposure control device 701 may be communicated with the depth sensor 702 to control automatic exposure of the depth sensor 702. The drone 700 may also include a fuselage 703 and a power system 704 disposed on the fuselage 703. The power system 704 may be used to provide flight power for the drone 700. In addition, the drone 700 may further include a bearing part 705 mounted on the fuselage 703, wherein the bearing part 705 may be a gimbal of two or three shafts. In some embodiments, the depth sensor 702 may be fixed or mounted on the fuselage 703. In some other embodiments, the depth sensor 702 may also be mounted on the bearing part 705. For illustration purpose, the depth sensor 702 is mounted on the fuselage 703. When the depth sensor 702 is mounted on the fuselage 703, the bearing part 705 may be used for carrying a photographing device 706 of the drone 700. A user may control the drone 700 through a control terminal, and receive images taken by the photographing device 706.

The disclosed systems, apparatuses, and methods may be implemented in other manners not described here. For example, the devices described above are merely illustrative. For example, the division of units may only be a logical function division, and there may be other ways of dividing the units. For example, multiple units or components may be combined or may be integrated into another system, or some features may be ignored, or not executed. Further, the coupling or direct coupling or communication connection shown or discussed may include a direct connection or an indirect connection or communication connection through one or more interfaces, devices, or units, which may be electrical, mechanical, or in other form.

The units described as separate components may or may not be physically separate, and a component shown as a unit may or may not be a physical unit. That is, the units may be located in one place or may be distributed over a plurality of network elements. Some or all of the components may be selected according to the actual needs to achieve the object of the present disclosure.

In addition, the functional units in the various embodiments of the present disclosure may be integrated in one processing unit, or each unit may be an individual physically unit, or two or more units may be integrated in one unit. The integrated unit may be implemented in the form of hardware. The integrated unit may also be implemented in the form of hardware plus software functional units.

The integrated unit implemented in the form of software functional unit may be stored in a non-transitory computer-readable storage medium. The software functional units may be stored in a storage medium. The software functional units may include instructions that enable a computer device, such as a personal computer, a server, or a network device, or a processor to perform part of a method consistent with embodiments of the disclosure, such as each of the exemplary methods described above. The storage medium may include any medium that can store program codes, for example, a USB disk, a mobile hard disk, a read-only memory (ROM), a random access memory (RAM), a magnetic disk, or an optical disk.

People skilled in the art may understand that for convenient and concise descriptions, above examples and illustrations are based only on the functional modules. In practical applications, the functions may be distributed to and implemented by different functional modules according to the need. That is, the internal structure of a device may be divided into different functional modules to implement all or partial functions described above. The specific operational process of a device described above may refer to the corresponding process in the embodiments described above, and no further details are illustrated herein.

Further, it should be noted that the above embodiments are used only to illustrate the technical solutions of the present disclosure and not to limit it to the present disclosure. Although the present disclosure is described in detail in the light of the foregoing embodiments, those of ordinary skill in the art should understand that they can still modify the technical solutions recorded in the preceding embodiments, or they can perform equivalent replacements for some or all of the technical features. The modifications or substitutions, however, do not make the nature of the corresponding technical solutions out of the scope of the technical solutions of each embodiment of the present disclosure.

What is claimed is:

1. An exposure control method for a control device, comprising:
acquiring an output image from data outputted by a depth sensor according to a current exposure parameter;
determining a target image of a target object in the output image; and
determining a first exposure parameter according to brightness of the target image, wherein the first exposure parameter is used for controlling a next exposure of the depth sensor.

2. The method according to claim 1, further comprising:
obtaining a depth image corresponding to the output image, wherein determining the target image in the output image includes:
determining the target image in the output image according to the depth image.

3. The method according to claim 2, wherein determining the target image in the output image according to the depth image includes:
determining a first target region of the target object in the output image according to the depth image; and
determining the target image in the output image according to the first target region.

4. The method according to claim 3, wherein determining the first target region of the target object in the output image according to the depth image includes:
determining a second target region of the target object in the depth image; and
determining the first target region of the target object in the output image according to the second target region of the target object.

5. The method according to claim 4, wherein determining the second target region of the target object in the depth image includes:
determining a plurality of connection regions in the depth image; and
determining one of the plurality of connection regions as the second target region of the target object in the depth image, the one of the plurality of connection regions satisfying a predetermined requirement.

6. The method according to claim 5, wherein determining whether the one of the plurality of connection regions satisfies the predetermined requirement includes:
determining an average depth of each connection region; and
determining the one of the plurality of connection regions as the second target region of the target object in the depth image, a pixel number of the one of the plurality of connection regions being greater than or equal to a pixel quantity threshold corresponding to an average depth of the one of the plurality of connection regions.

7. The method according to claim 6, wherein determining the one of the plurality of connection regions as the second target region of the target object in the depth image, the pixel number of the one of the plurality of connection regions being greater than or equal to the pixel quantity threshold corresponding to the average depth of the one of the plurality of connection regions, includes:
determining the one of the plurality of connection regions as the second target region of the target object in the depth image, the pixel number of the one of the plurality of connection regions being greater than or equal to the pixel quantity threshold corresponding to the average depth of the one of the plurality of connection regions and the average depth of the one of the plurality of connection regions being the smallest.

8. The method according to claim 2, wherein acquiring the output image includes:
acquiring at least two of the output images from the data, wherein acquiring the depth image corresponding to the at least two of the output images includes:
acquiring the depth image according to the at least two of the output images.

9. The method according to claim 8, wherein determining the target image in the output image according to the depth image includes:
determining the target image from one of the at least two of the output images according to the depth image.

10. The method according to claim 1, wherein determining the first exposure parameter according to the brightness of the target image includes:
determining average brightness of the target image: and
determining the first exposure parameter according to the average brightness.

11. The method according to claim 10, wherein determining the first exposure parameter according to the average brightness includes:
determining the first exposure parameter according to the average brightness and preset brightness.

12. The method according to claim 11, wherein determining the first exposure parameter according to the average brightness and the preset brightness includes:
determining a difference value between the average brightness and the preset brightness; and
determining the first exposure parameter according to the difference value when the difference value is greater than a brightness threshold value.

13. The method according to claim 12, wherein the first exposure parameter is used as a current exposure parameter, steps including the step of determining the difference value and the step of determining the first exposure parameter are repeated until the difference value is less than or equal to the brightness threshold value, the current exposure parameter is locked into a final exposure parameter for controlling automatic exposure of the depth sensor after the difference value is less than or equal to the brightness threshold value.

14. The method according to claim 1, wherein the depth sensor includes one or more of a binocular camera, a monocular camera, an RGB camera, a TOF camera, or an RGB-D camera.

15. The method according to claim 1, wherein the first exposure parameter includes at least one of an exposure time, an exposure gain, or an aperture value.

16. An exposure control device comprising:
a memory device; and
a processor;
wherein the memory device is configured to store program instructions, the processor is configured to call the program instructions, the processor operable when executing the program instructions to:
acquire an output image from data outputted by a depth sensor according to a current exposure parameter;
determine a target image of a target object in the output image; and
determine a first exposure parameter according to brightness of the target image, wherein the first exposure parameter is used for controlling a next automatic exposure of the depth sensor.

17. The device according to claim 16, wherein the processor is configured to acquire a depth image corresponding to the output image and determine the target image in the output image according to the depth image when the processor determines the target image in the output image.

18. The device according to claim 17, wherein the processor, when determining the target image in the output image according to the depth image, is configured to determine a first target region of the target object in the output image according to the depth image and determine the target image in the output image according to the first target region.

19. The device according to claim 18, wherein the processor, when determining the first target region of the target object in the output image according to the depth image, is configured to determine a second target region of the target object in the depth image and determine the first target region of the target object in the output image according to the second target region.

20. The device according to claim 19, wherein the processor, when determining the second target region of the target object in the depth image, is configured to determine a plurality of connection regions in the depth image and determine one of the plurality of connection regions as the second target region of the target object in the depth image, the one of the plurality of connection regions satisfying a predetermined requirement.
